(19) United States
(12) Patent Application Publication
(10) Pub. No.: US 2026/0085959 A1
(43) Pub. Date: Mar. 26, 2026

(54) Capacitance Sensor

(71) Applicant: SEIKO EPSON CORPORATION, Tokyo (JP)

(72) Inventors: Hisahiro ITO, Minowa (JP); Tatsuya OTA, Minowa (JP); Akio TSUTSUMI, Chino (JP); Hideo HANEDA, Shiojiri (JP)

(21) Appl. No.: 19/333,845

(22) Filed: Sep. 19, 2025

(30) Foreign Application Priority Data
Sep. 20, 2024 (JP) 2024-163995
Oct. 2, 2024 (JP) 2024-172946

(51) Int. Cl. G01F 23/263

(52) U.S. Cl. CPC G01F 23/266

(57) ABSTRACT

A capacitance sensor includes a package, an oscillation circuit included in the package, and a first electrode and a second electrode that are disposed outside the package. The oscillation circuit includes an amplifier and a vibrator included in the package and connected between an input node and an output node of the amplifier. The first electrode is a sensing electrode connected to one of the input node and the output node of the amplifier. The second electrode has a fixed potential. An oscillation frequency of the oscillation circuit changes in accordance with a first electrostatic capacitance between the first electrode and the second electrode.

The present application is based on, and claims priority from JP Application Serial Number 2024-163995, filed Sep. 20, 2024 and JP Application Serial Number 2024-172946, filed Oct. 2, 2024, the disclosures of which are hereby incorporated by reference herein in their entirety.

### BACKGROUND

### 1. Technical Field

The present disclosure relates to a capacitance sensor.

### 2. Related Art

JP-A-2003-57095 describes a liquid level detector in which an oscillation circuit is caused to oscillate by using, as an oscillation time constant, an electrostatic capacitance and a resistance which change in accordance with a change in a liquid level to be measured, and a digital signal corresponding to the change in the liquid level is output based on an output signal of the oscillation circuit.

However, in the liquid level detector described in JP-A-2003-57095, since the oscillation circuit oscillates by charging and discharging of an electrostatic capacitance, an oscillation frequency of the oscillation circuit tends to fluctuate due to an influence of external amplitude noise, and it is difficult to realize high detection accuracy.

### SUMMARY

According to an aspect of the present disclosure, a capacitance sensor includes a package, an oscillation circuit included in the package, and a first electrode and a second electrode that are disposed outside the package. The oscillation circuit includes an amplifier and a vibrator included in the package and connected between an input node and an output node of the amplifier. The first electrode is a sensing electrode connected to one of the input node and the output node of the amplifier. The second electrode has a fixed potential. An oscillation frequency of the oscillation circuit changes in accordance with a first electrostatic capacitance between the first electrode and the second electrode.

According to another aspect of the present disclosure, a capacitance sensor includes an oscillation circuit, a first electrode, and a second electrode. The oscillation circuit includes an amplifier and a vibrator connected between an input node and an output node of the amplifier. The first electrode is a sensing electrode connected to one of the input node and the output node of the amplifier. The second electrode has a fixed potential. An electrostatic capacitance between the first electrode and the second electrode changes in accordance with a state of a detection target. An oscillation frequency of the oscillation circuit changes in accordance with a first electrostatic capacitance between the first electrode and the second electrode.

### BRIEF DESCRIPTION OF THE DRAWINGS

FIG. 1 is a diagram illustrating an appearance of a capacitance sensor according to a first embodiment.

FIG. 2 is a plan view illustrating an example of an internal structure of an oscillator.

FIG. 3 is a plan view illustrating another example of the internal structure of the oscillator.

FIG. 4 is a diagram illustrating an example of use of the capacitance sensor.

FIG. 5 is a functional block diagram illustrating the capacitance sensor according to the first embodiment.

FIG. 6 is a diagram illustrating a configuration example of a drive circuit and a buffer circuit.

FIG. 7 is a diagram illustrating an equivalent circuit of a vibrator.

FIG. 8 is a diagram illustrating an example of the relationship between a load capacitance C_{L} and a normalized frequency Δf/f₀.

FIG. 9 is a timing chart of various signals.

FIG. 10 is a diagram illustrating a comparison of frequency variable characteristics with respect to the load capacitance C_{L} between an LC oscillation circuit and an oscillation circuit using a vibrator.

FIG. 11 is a diagram illustrating an appearance of a capacitance sensor according to a second embodiment.

FIG. 12 is a functional block diagram illustrating the capacitance sensor according to the second embodiment.

FIG. 13 is a diagram illustrating a configuration example of a drive circuit and a buffer circuit.

### DESCRIPTION OF EMBODIMENTS

Hereinafter, preferred embodiments of the present disclosure will be described in detail with reference to the drawings. It should be noted that the embodiments described below do not unduly limit the contents of the present disclosure described in the appended claims. Furthermore, not all of the configurations described below are essential constituent elements of the present disclosure.

### 1. First Embodiment

### 1-1. Structure of Capacitance Sensor

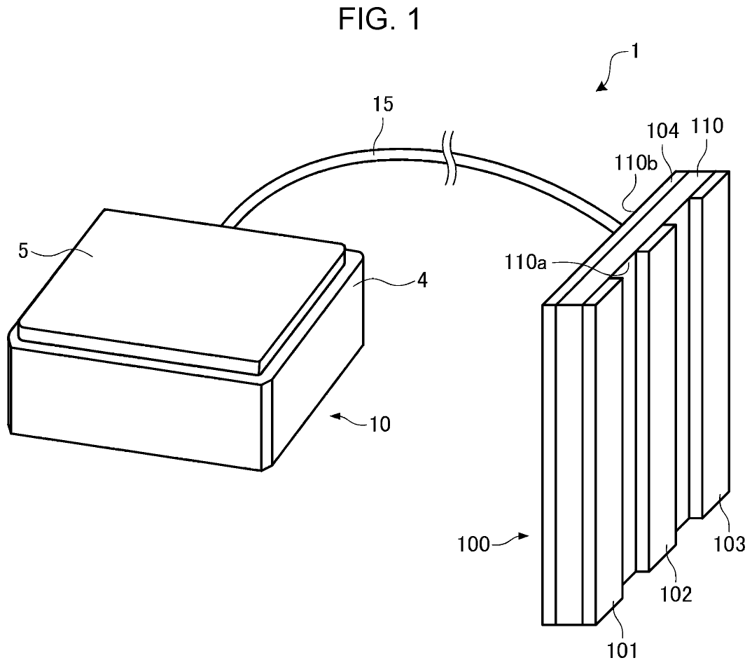

FIG. 1 is a diagram illustrating an appearance of a capacitance sensor 1 according to a first embodiment. As illustrated in FIG. 1, the capacitance sensor 1 of the first embodiment includes an oscillator 10, a sensing section 100, and a cable 15 that connects the oscillator 10 and the sensing section 100 to each other.

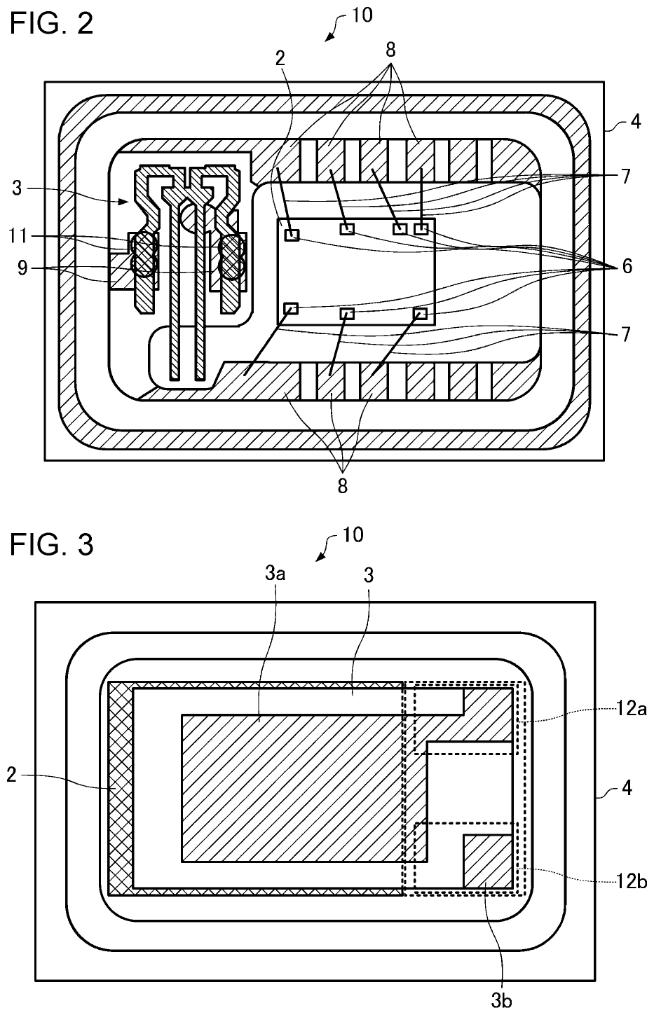

FIG. 2 is a plan view illustrating an example of an internal structure of the oscillator 10. As illustrated in FIGS. 1 and 2, the oscillator 10 includes a circuit device 2, a vibrator 3, a package 4, and a lid 5. In FIG. 2, illustration of the lid 5 is omitted.

The oscillator 10 has, for example, a single seal structure, and the package 4 is a container that accommodates the circuit device 2 and the vibrator 3 in the same space. That is, the circuit device 2 and the vibrator 3 are installed inside the package 4. Specifically, a recessed portion is formed in the package 4, and the circuit device 2 and the vibrator 3 are accommodated by the recessed portion being covered with the lid 5. The oscillator 10 do not necessarily have a single seal structure, and for example, the package 4 may be a container in which the circuit device 2 and the vibrator 3 are accommodated in different spaces. Specifically, the package 4 may have two recessed portions on opposite surfaces, the vibrator 3 may be accommodated by one of the recessed portions being covered with the lid 5, and the circuit device 2 may be accommodated by the other recessed portion being covered with a sealing member.

In this embodiment, the circuit device 2 is realized by a one-chip integrated circuit. However, at least a portion of the circuit device 2 may be constituted by discrete components. In the example of FIG. 2, the circuit device 2 is mounted on an inner bottom surface of the package 4 by using an adhesive or the like such that a surface on which a plurality of pads 6 are formed serves as an upper surface. Each of the plurality of pads 6 is connected to a corresponding one of a plurality of electrodes 8 formed on a surface of the recessed portion of the package 4 by a corresponding one of bonding wires 7.

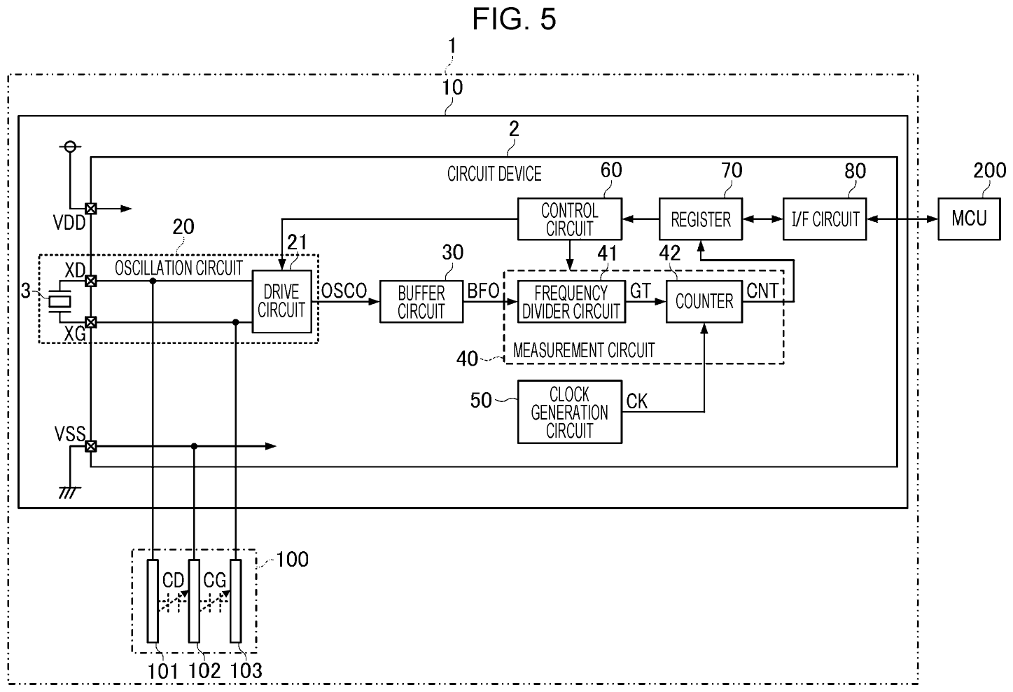

The vibrator 3 is a piezoelectric vibrator using, as a substrate material, a piezoelectric material including a piezoelectric single crystal, such as quartz crystal, lithium tantalate, or lithium niobate, and a piezoelectric ceramic, such as lead zirconate titanate. Alternatively, the vibrator 3 is a micro electro mechanical systems (MEMS) vibrator which uses a silicon substrate or the like as a substrate material and is excited by electrostatic attractive force. For example, the vibrator 3 is a quartz crystal vibrator using quartz crystal as a substrate material, and is a tuning fork type quartz crystal vibrator in the example of FIG. 2. Two support arms of the vibrator 3 are bonded to respective two electrodes 9 formed on a surface of the recessed portion of the package 4 by a conductive bonding member 11. That is, the support arms of the vibrator 3 are fixed to and electrically connected to the corresponding electrodes 9. The two electrodes 9 are electrically connected to two of the electrodes 8 and two of the pads 6 of the circuit device 2, specifically, an XD terminal and an XG terminal of FIG. 5 to be described later, respectively, by wiring lines provided in the package 4.

Electrode patterns (not illustrated) are individually formed on the two support arms and two vibrating arms of the vibrator 3. Then, a signal generated in one of the electrode patterns is supplied from a corresponding one of the electrodes 8 to the XG terminal of the circuit device 2, an amplifier included in the circuit device 2 amplifies the signal, and the amplified signal is supplied from the XD terminal to the vibrator 3 via the other electrode 9, whereby the two vibrating arms of the vibrator 3 continue to vibrate like a tuning fork. Thus, an oscillation circuit including the vibrator 3 and the amplifier oscillates.

FIG. 3 is a plan view illustrating another example of the internal structure of the oscillator 10. In the example of FIG. 3, the circuit device 2 is mounted on the bottom surface of the recessed portion of the package 4, and the vibrator 3 is mounted over the circuit device 2 with a gap provided therebetween.

In the example of FIG. 3, the vibrator 3 is an AT cut quartz crystal resonator. The vibrator 3 has metal excitation electrodes 3a and 3b on a front surface and a rear surface thereof, and vibrates at a desired frequency corresponding to a shape and a mass of the vibrator 3 including the excitation electrodes 3a and 3b. The excitation electrodes 3a and 3b are bonded to two electrodes 12a and 12b, respectively, formed on the surface of the recessed portion of the package 4. The package 4 includes wiring lines (not illustrated) for electrically connecting the two terminals of the circuit device 2, that is, the XD and XG terminals of FIG. 5 to be described later and the electrodes 12a and 12b to each other. Then, a signal generated in one of the excitation electrodes 3a and 3b is supplied to the XG terminal of the circuit device 2, an amplifier included in the circuit device 2 amplifies the signal, and the amplified signal is supplied from the XD terminal to the vibrator 3 via the other of the excitation electrodes 3a and 3b, whereby thickness-shear vibration in which a front surface and a rear surface of the vibrator 3 move in opposite directions to each other is continued. Thus, the oscillation circuit including the vibrator 3 and the amplifier oscillates.

In the oscillator 10, a plurality of external connection terminals (not illustrated) are disposed on the rear surface of the package 4 which is the bottom surface. In addition, the package 4 includes wiring lines (not illustrated) for electrically connecting the individual terminals of the circuit device 2 and the external connection terminals disposed on the bottom surface of the package 4.

As illustrated in FIG. 1, the sensing section 100 is provided outside the package 4 of the oscillator 10, and is connected to the oscillator 10 by the cable 15. For example, the cable 15 may be a coaxial cable, a flexible flat cable, or the like.

The sensing section 100 includes a substrate 110 having a surface 110a and a surface 110b which is a rear surface of the surface 110a. Electrodes 101, 102, and 103 are disposed on the surface 110a of the substrate 110. Each of the electrodes 101, 102, and 103 has an elongated rectangular shape, and the electrode 102 is located between the electrodes 101 and 103. On the surface 110b of the substrate 110, an electrode 104 is disposed at a position facing a region of arrangement of the electrodes 101, 102, and 103 on the surface 110a. For example, the electrode 104 is disposed on substantially the entire surface of the surface 110b.

The electrodes 101, 102, 103, and 104 are individually connected to an external connection terminal of the oscillator 10 by wiring lines included in the cable 15. The electrodes 101, 102, 103, and 104 are therefore individually connected to the terminals of the circuit device 2 via the external connection terminal of the oscillator 10.

In this embodiment, the electrode 101 is a sensing electrode connected to one of the XD terminal and the XG terminal of the circuit device 2, and the electrode 103 is a sensing electrode connected to the other of the XD terminal and the XG terminal of the circuit device 2. The electrode 102 has a fixed potential. For example, the electrode 102 is connected to a ground terminal of the circuit device 2, and a potential thereof is fixed to the ground potential. The electrode 104 is connected to the ground terminal of the circuit device 2, and the potential thereof is fixed to the ground potential.

The sensing section 100 is disposed such that the electrodes 101, 102, and 103 face a detection target of an electrostatic capacitance. An electrostatic capacitance CD between the electrode 101 and the electrode 102 and an electrostatic capacitance CG between the electrode 103 and the electrode 102 change according to a dielectric constant of the detection target.

As will be described later, when the electrostatic capacitances CD and CG change, a load capacitance C_{L} of the vibrator 3 also changes, and an oscillation frequency f of the oscillation circuit changes. Therefore, the circuit device 2 measures the oscillation frequency f and outputs a measurement value of the oscillation frequency f to the outside of the oscillator 10. The external device can determine a state of the detection target by capturing the changes in the electrostatic capacitances CD and CG based on the measurement value of the oscillation frequency f. Note that when an object that is not the detection target is positioned to face the surface 110b of the substrate 110, the electrode 104 functions as a shield member for reducing the influence of the object on the electrostatic capacitances CD and CG.

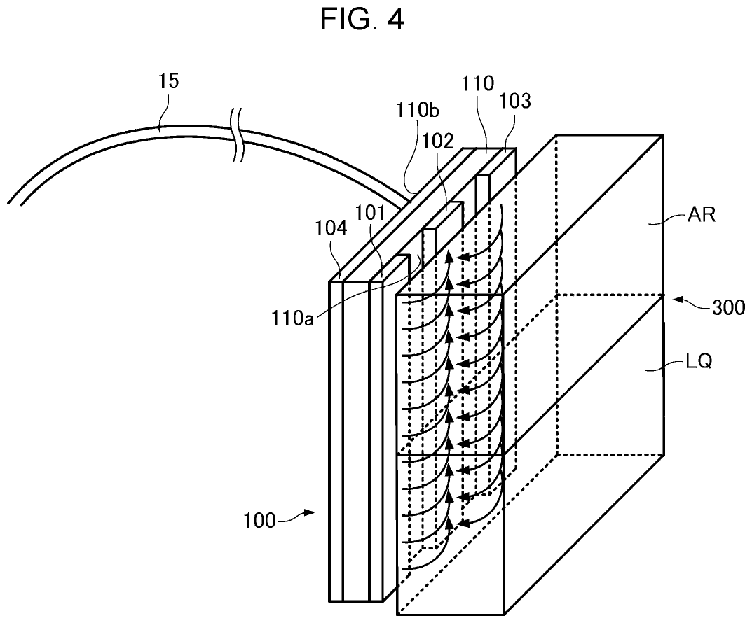

FIG. 4 is a diagram illustrating an example of use of the capacitance sensor 1. In the example of FIG. 4, a detection target 300 whose capacitance is to be detected is a container that contains liquid LQ. An internal space of the detection target 300 is filled with the liquid LQ and air AR, the air AR increases when the liquid LQ decreases, and the air AR decreases when the liquid LQ increases. A dielectric constant of the liquid LQ is several tens of times a dielectric constant of the air AR, and an effective dielectric constant inside the detection target 300 increases as an amount of the liquid LQ increases. On the other hand, the electrostatic capacitances CD and CG increase or decrease in proportion to the dielectric constant of the detection target 300. Therefore, as the dielectric constant of the detection target 300 increases, that is, as an amount of the liquid LQ increases, the electrostatic capacitances CD and CG increase, and thus the load capacitance C_{L} of the vibrator 3 increases. Therefore, the external device can calculate the amount of the liquid LQ accommodated in the detection target 300 based on the measurement value of the oscillation frequency f output from the oscillator 10.

### 1-2. Constructive Configuration of Capacitance Sensor

FIG. 5 is a functional block diagram of the capacitance sensor 1 according to the first embodiment. As illustrated in FIG. 5, the capacitance sensor 1 of the first embodiment includes the circuit device 2 and the sensing section 100.

The circuit device 2 includes a drive circuit 21, a buffer circuit 30, a measurement circuit 40, a clock generation circuit 50, a control circuit 60, a register 70, and an interface circuit 80. Note that the circuit device 2 may have a configuration in which some of these components are omitted or changed, or other components are added.

The circuit device 2 includes a VDD terminal which is a power supply terminal and a VSS terminal which is a ground terminal, and the individual circuits operate with a potential of the VDD terminal as a power supply potential and a potential of the VSS terminal as a ground potential. In addition, the circuit device 2 includes the XD terminal and the XG terminal, and the XD terminal and the XG terminal are connected to opposite ends of the vibrator 3. The circuit device 2 further includes a terminal (not illustrated) for performing data communication with an MCU 200 which is an external device of the circuit device 2.

The drive circuit 21 is connected to the XD terminal and the XG terminal, and generates an oscillation signal OSCO by vibrating the vibrator 3. The drive circuit 21 amplifies a signal input from the vibrator 3 via the XG terminal and outputs the amplified signal to the vibrator 3 via the XD terminal. Accordingly, the two vibrating arms of the vibrator 3 vibrate, and the drive circuit 21 outputs a signal input from the vibrator 3 via the XG terminal as the oscillation signal OSCO. The vibrator 3 and the drive circuit 21 constitute an oscillation circuit 20.

The buffer circuit 30 buffers the oscillation signal OSCO output from the drive circuit 21 and outputs a signal BFO of a rectangular wave. Note that examples of the rectangular wave of the signal BFO include not only a strict rectangular wave but also a waveform close to a rectangular wave.

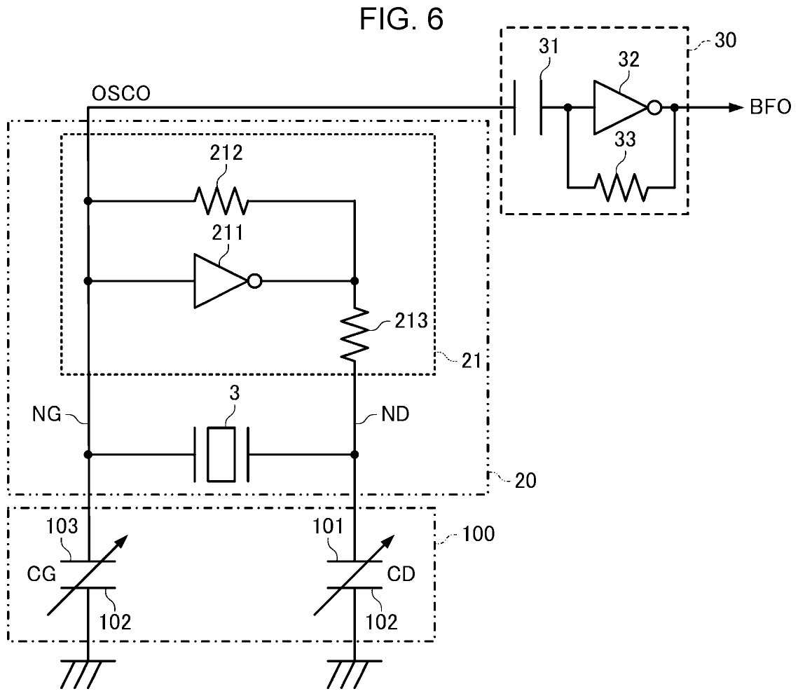

FIG. 6 is a diagram illustrating a configuration example of the drive circuit 21 and the buffer circuit 30. As illustrated in FIG. 6, the drive circuit 21 includes an amplifier 211 and resistors 212 and 213.

The amplifier 211 amplifies a signal output from the vibrator 3 and outputs the amplified signal to the vibrator 3 via the resistor 213. In the example of FIG. 6, the amplifier 211 is a CMOS inverter circuit, but may be a bipolar transistor.

The vibrator 3 is connected between a node NG and a node ND. The node NG is an input node of the amplifier 211, and a signal output from the vibrator 3 is input to the amplifier 211 through the node NG. The node ND is an output node of the amplifier 211, and a signal output from the amplifier 211 is output to the node ND via the resistor 213. The node NG is connected to the XG terminal, and the node ND is connected to the XD terminal.

A signal output from the amplifier 211 is a rectangular wave signal, and the rectangular wave signal is input to the vibrator 3. As illustrated in FIGS. 2 and 3, the vibrator 3 is, for example, a tuning fork type quartz crystal vibrator or an AT cut quartz crystal vibrator, and has a very high Q value, and thus the signal output from the vibrator 3 has little noise and is close to a sine wave. The signal output from the vibrator 3 to the node NG is input to the buffer circuit 30 as the oscillation signal OSCO. Note that examples of the rectangular wave of the signal output from the amplifier 211 include not only a strict rectangular wave but also a waveform close to a rectangular wave.

The buffer circuit 30 includes a capacitor 31, a CMOS inverter circuit 32, and a resistor 33. The oscillation signal OSCO is input to the CMOS inverter circuit 32 via the capacitor 31, and the CMOS inverter circuit 32 outputs the rectangular wave signal BFO.

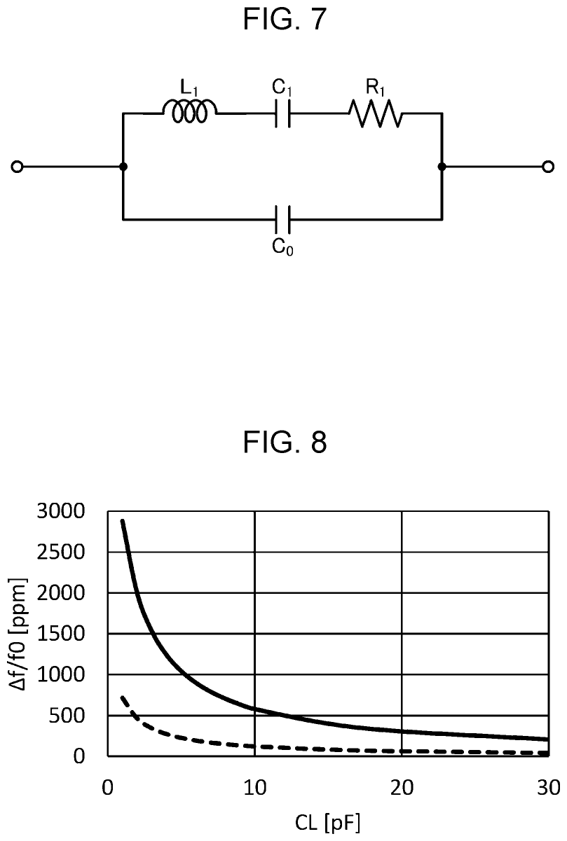

Here, FIG. 7 is a diagram illustrating an equivalent circuit of the vibrator 3 which is a quartz crystal vibrator, and examples of equivalent constant of the vibrator 3 include a series inductance L₁, a series capacitance C₁, a series resistance R₁, and a parallel capacitance C₀. Here, a series resonance frequency f₀ of the vibrator 3 is expressed by Expression (1).

$${f}_{0} = \frac{1}{2 π} \sqrt{\frac{1}{{L}_{1} {C}_{1}}} \qquad ( 1 )$$

The oscillation frequency f of the oscillation circuit 20 constituted by the vibrator 3 and the drive circuit 21 changes depending on the load capacitance C_{L}, and a normalized frequency Δf/f₀ of the oscillation circuit 20 is expressed by Expression (2).

$$\frac{Δ f}{{f}_{0}} = \frac{f - {f}_{0}}{{f}_{0}} = \frac{1}{2 γ} \frac{1}{1 + \frac{{C}_{L}}{{C}_{0}}} \qquad ( 2 )$$

In Expression (2), γ is a ratio between the parallel capacitance C₀ and the series capacitance C₁, and is expressed by Expression (3).

$$γ = \frac{{C}_{0}}{{C}_{1}} \qquad ( 3 )$$

FIG. 8 is a diagram illustrating an example of the relationship between the load capacitance C_{L} and the normalized frequency Δf/f₀. In FIG. 8, a solid line is a graph obtained in a case where the vibrator 3 is a tuning fork type quartz crystal vibrator, and a broken line is a graph obtained in a case where the vibrator 3 is an AT cut quartz crystal vibrator. As can be seen from FIG. 8, when the load capacitance C_{L} changes in a range from 0 to 30 pf, the normalized frequency Δf/f₀ also changes, and a rate of the change is larger in the tuning fork type quartz crystal vibrator.

The electrode 101 of the sensing section 100 is connected to one of the input node NG and the output node ND of the amplifier 211, and the electrode 103 of the sensing section 100 is connected to the other of the input node NG and the output node ND of the amplifier 211. In FIGS. 5 and 6, the electrode 101 is connected to the output node ND of the amplifier 211, and the electrode 103 is connected to the input node NG of the amplifier 211. The electrode 102 of the sensing section 100 is connected to the ground. Therefore, the load capacitance C_{L} of the vibrator 3 is configured by the electrostatic capacitance CD between the electrodes 101 and 102 and the electrostatic capacitance CG between the electrodes 103 and 102, and is expressed by Expression (4). In Expression (4), CS indicates a stray capacitance, which is about several pF.

$${C}_{L} = \frac{CG \times CD}{CG + CD} + CS \qquad ( 4 )$$

According to Expressions (1) to (4), the oscillation frequency f of the oscillation circuit 20 changes in accordance with the electrostatic capacitances CD and CG. A frequency of the oscillation signal OSCO output from the drive circuit 21 is the oscillation frequency f, and the frequency of the signal BFO output from the buffer circuit 30 also matches the oscillation frequency f.

As illustrated in FIG. 5, the measurement circuit 40 measures a frequency of the signal BFO output from the buffer circuit 30. That is, the measurement circuit 40 measures the oscillation frequency f. For example, the measurement circuit 40 includes a frequency divider circuit 41 and a counter 42.

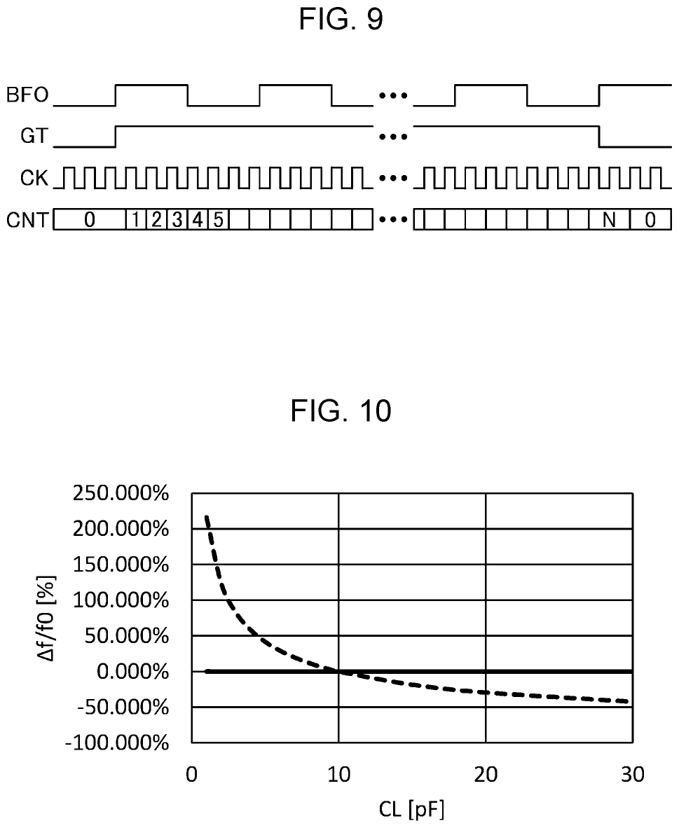

The frequency divider circuit 41 outputs a gate time signal GT obtained by dividing the frequency of the signal BFO. The counter 42 counts the number of pulses of a clock signal CK included in a gate time which is defined by the gate time signal GT, and outputs a count value CNT. For example, as illustrated in a timing chart of FIG. 9, the frequency divider circuit 41 outputs the gate time signal GT which is at a high level for a period of time of a predetermined cycle of the signal BFO, and the counter 42 outputs the count value CNT of the number of pulses of the clock signal CK included in the period of time in which the gate time signal GT is at the high level. In this case, the period of time in which the gate time signal GT is at the high level corresponds to the gate time.

The count value CNT corresponds to a ratio between a frequency of the clock signal CK and a frequency of the signal BFO, and the count value CNT decreases as the frequency of the signal BFO increases. That is, the frequency of the signal BFO and the count value CNT have a one to-one relationship, and the count value CNT corresponds to the frequency of the signal BFO, that is, the measurement value of the oscillation frequency f. The count value CNT is stored in the register 70.

The longer the gate time is, the higher a measurement resolution of the measurement circuit 40 is, but the longer a period of time required for the measurement is. Therefore, the gate time is appropriately set according to an upper limit value of an allowable measurement time, and is set to, for example, several hundred milliseconds.

The clock signal CK is output from the clock generation circuit 50. As a frequency of the clock signal CK increases, the measurement resolution of the measurement circuit 40 increases. Therefore, for example, the clock generation circuit 50 may be a ring oscillator capable of outputting a signal of several tens of MHz to several hundreds of MHz. In addition, the clock signal CK may be output from the clock generation circuit 50 in the gate time during which the gate time signal GT is at a predetermined logic level, for example, in a gate time during which the gate time signal GT is at a high level. Therefore, while the capacitance sensor 1 is operating, the clock signal CK may be continuously output from the clock generation circuit 50, but a period of time in which the output of the clock signal CK from the clock generation circuit 50 is stopped may be provided separately from the gate time. In this case, power consumption of the capacitance sensor 1 can be suppressed.

The control circuit 60 controls the operation of the oscillation circuit 20. For example, the control circuit 60 outputs an enabling signal to the oscillation circuit 20, and the oscillation circuit 20 oscillates when the enabling signal is at a high level and stops the oscillation when the enabling signal is at a low level. The control circuit 60 also controls the operation of the measurement circuit 40. For example, the control circuit 60 outputs a signal for instructing the measurement circuit 40 to start measurement, and the measurement circuit 40 performs a measurement process in response to the signal for instructing the measurement circuit 40 to start measurement.

The interface circuit 80 is used to perform data communication with the MCU 200. For example, when receiving a measurement request from the MCU 200, the interface circuit 80 rewrites a predetermined bit of the register 70 from 0 to 1. When detecting that the bit has been rewritten, the control circuit 60 causes the oscillation circuit 20 to start an oscillation operation, and outputs a signal for instructing the measurement circuit 40 to start measurement after a predetermined waiting time elapses.

In addition, for example, when receiving a request for reading a measurement value from the MCU 200, the interface circuit 80 reads the count value CNT stored in the register 70 and transmits the count value CNT to the MCU 200. When receiving the count value CNT, the MCU 200 may calculate the load capacitance C_{L} or determine a state of the detection target, based on the count value CNT.

The interface circuit 80 may be, for example, an interface circuit of an SPI bus or an interface circuit of an I²C bus. SPI is an abbreviation for Serial Peripheral Interface, and I²C is an abbreviation for Inter-Integrated Circuit.

Note that the electrode 101 is an example of a “first electrode”, the electrode 102 is an example of a “second electrode”, the electrode 103 is an example of a “third electrode”, and the electrode 104 is an example of a “ground electrode”. Furthermore, the electrostatic capacitance CD is an example of a “first electrostatic capacitance”, and the electrostatic capacitance CG is an example of a “second electrostatic capacitance”. The surface 110a of the substrate 110 is an example of a “first surface”, and the surface 110b of the substrate 110 is an example of a “second surface”.

### 1-3. Operation and Effect

As described above, in the capacitance sensor 1 according to the first embodiment, the oscillation circuit 20 oscillates not based on CR oscillation based on charging and discharging of the electrostatic capacitances CD and CG but based on resonance between the vibrator 3 and the electrostatic capacitances CD and CG. Therefore, the oscillation circuit 20 is less likely to be affected by external amplitude noise. Therefore, according to the capacitance sensor 1 of the first embodiment, it is possible to detect an electrostatic capacitance with high accuracy.

In addition, in the capacitance sensor 1 of the first embodiment, since the oscillation frequency of the oscillation circuit 20 changes according to the electrostatic capacitances CD and CG, it is possible to widen a variable width of the oscillation frequency compared to a case where the electrostatic capacitance CG does not exist, that is, a case where the electrode 103 does not exist in the sensing section 100. Therefore, according to the capacitance sensor 1 of the first embodiment, it is possible to improve the detection sensitivity of an electrostatic capacitance.

In addition, in the capacitance sensor 1 according to the first embodiment, the vibrator 3 has a very high Q value, and therefore, also functions as a noise filter, and the signal output from the vibrator 3 to the input node NG of the amplifier 211 has little noise and is close to a sine wave. Therefore, according to the capacitance sensor 1 of the first embodiment, since a spike due to noise does not occur in the output signal of the buffer circuit 30, the possibility that the measurement circuit 40 performs erroneous measurement is reduced.

In addition, in the capacitance sensor 1 of the first embodiment, since the electrode 104 is disposed on the surface 110b of the substrate 110 at a position facing the region of the arrangement of the electrodes 101, 102, and 103 on the surface 110a, when an object that is not a detection target is positioned to face the surface 110b, the influence of the object on the electrostatic capacitances CD and CG is reduced. Therefore, according to the capacitance sensor 1 of the first embodiment, it is possible to improve the detection accuracy of the electrostatic capacitance.

Meanwhile, as illustrated in FIG. 10, an LC oscillation circuit using an LC resonance constituted by an inductor and an electrostatic capacitance has a wide variable width of an oscillation frequency compared to an oscillation circuit using a vibrator and an electrostatic capacitance. FIG. 10 is a diagram illustrating an example of the relationship between the load capacitance C_{L} and the normalized frequency Δf/f₀. A solid line is a graph in a case where the vibrator 3 is a tuning fork type quartz crystal vibrator, and corresponds to the solid line graph of FIG. 8. A broken line is a graph in the case of an LC oscillation circuit. As is apparent from FIG. 10, it is understood that a variable width of the oscillation circuit using a vibrator and a capacitance is extremely narrow as compared with a variable width of the oscillation frequency of the LC oscillation circuit.

Therefore, it is also considered to configure a capacitance sensor having high detection sensitivity using the LC oscillation circuit. However, for example, in a case where an electrostatic capacitance of the pF order is detected by the capacitance sensor using the LC oscillation circuit, when a small-sized inductor of the nH order is used in order to realize cost reduction, an oscillation frequency becomes the GHz order, and various problems, such as an increase in size or power consumption of the circuit for measuring the electrostatic capacitance, may occur. On the other hand, in order to set the oscillation frequency to the MHz order, an inductor having a large size of the μh order is required to be used, which is an obstacle to the reduction in size and cost of the capacitance sensor.

On the other hand, in the capacitance sensor 1 of this embodiment, the oscillation circuit 20 using the vibrator 3 and the electrostatic capacitances CD and CG has a considerably narrower variable width of the oscillation frequency than the LC oscillation circuit, but can easily realize the oscillation frequency of the kHz order or the MHz order using the small-sized vibrator 3, and for example, with respect to an electrostatic capacitance of the pF order, as illustrated in FIG. 8, a practically required variable width of the oscillation frequency can be obtained. Furthermore, since an inductance value of an inductor is determined by a size, it is difficult to reduce the size of the inductor without changing the inductance value. On the other hand, in the vibrator 3, further miniaturization and cost reduction can be realized by the progress of the manufacturing process in the future. Therefore, according to the capacitance sensor 1 of the first embodiment, since it is possible to realize a reduction in size and a reduction in cost as compared to a capacitance sensor using an LC oscillation circuit, for example, the capacitance sensor 1 can be easily used even when the detection target is a small object.

### 2. Second Embodiment

Hereinafter, regarding a second embodiment, the same reference numerals will be assigned to the same components as those of the first embodiment, the same description as that of the first embodiment will be omitted or simplified, and contents different from those of the first embodiment will be mainly described.

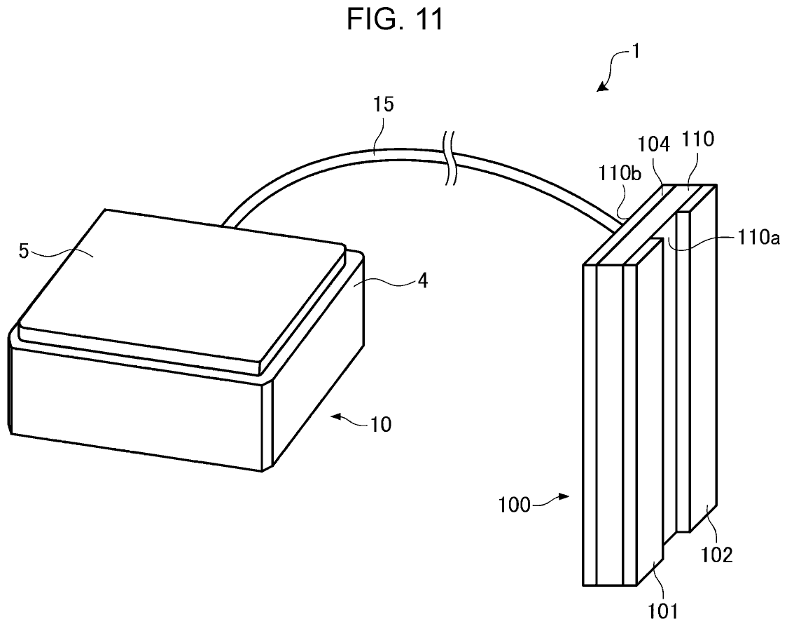

FIG. 11 is a view illustrating an appearance of a capacitance sensor 1 of the second embodiment. As illustrated in FIG. 11, the capacitance sensor 1 according to the second embodiment includes an oscillator 10, a sensing section 100, and a cable 15 connecting the oscillator 10 and the sensing section 100 to each other, similarly to the capacitance sensor 1 according to the first embodiment. Since a structure of the oscillator 10 is the same as that of the first embodiment, the illustration and description thereof will be omitted.

As illustrated in FIG. 11, the sensing section 100 is provided outside a package 4 of the oscillator 10, and is connected to the oscillator 10 by the cable 15. For example, the cable 15 may be a coaxial cable, a flexible flat cable, or the like.

The sensing section 100 includes a substrate 110 having a surface 110a and a surface 110b which is a rear surface of the surface 110a. Electrodes 101 and 102 are disposed on the surface 110a of the substrate 110. On the surface 110b of the substrate 110, an electrode 104 is disposed at a position facing a region of arrangement of the electrodes 101 and 102 on the surface 110a. For example, the electrode 104 is disposed on substantially the entire surface of the surface 110b.

The electrodes 101, 102, and 104 are individually connected to an external connection terminal of the oscillator 10 by wiring lines included in the cable 15. The electrodes 101, 102, and 104 are therefore individually connected to terminals of a circuit device 2 via the external connection terminal of the oscillator 10.

In this embodiment, the electrode 101 is a sensing electrode connected to an XD terminal of a circuit device 2, and the electrode 102 has a fixed potential. For example, the electrode 102 is connected to a VSS terminal which is a ground terminal of the circuit device 2, and a potential thereof is fixed to the ground potential. The electrode 104 is connected to the VSS terminal of the circuit device 2, and a potential thereof is fixed to the ground potential.

The sensing section 100 is arranged such that the electrodes 101 and 102 face a detection target of a capacitance. A capacitance CD between the electrode 101 and the electrode 102 changes according to a dielectric constant of the detection target.

When the electrostatic capacitance CD changes, a load capacitance C_{L} of a vibrator 3 also changes, and an oscillation frequency f of an oscillation circuit 20 changes. Therefore, the circuit device 2 measures the oscillation frequency f and outputs a measurement value of the oscillation frequency f to the outside of the oscillator 10. The external device can determine a state of the detection target by capturing a change in the electrostatic capacitance CD based on the measurement value of the oscillation frequency f. Note that when an object that is not the detection target is positioned to face the surface 110b of the substrate 110, the electrode 104 functions as a shield member for reducing the influence of the object on the capacitance CD.

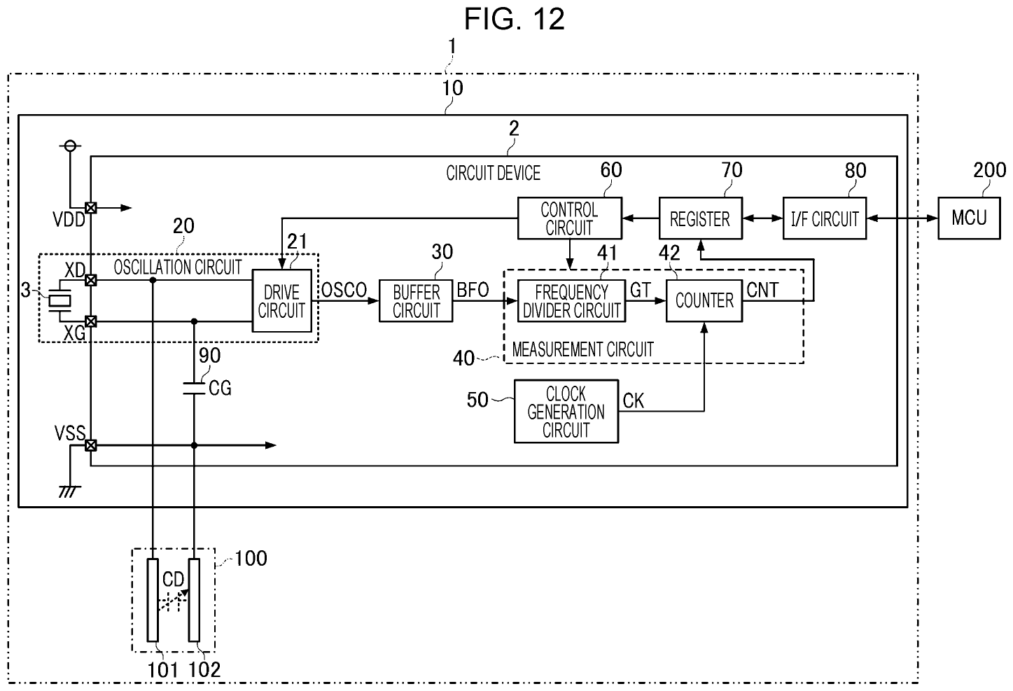

FIG. 12 is a functional block diagram of the capacitance sensor 1 according to the second embodiment. As illustrated in FIG. 12, the capacitance sensor 1 of the second embodiment includes the circuit device 2 and the sensing section 100, similarly to the capacitance sensor 1 of the first embodiment.

As in the first embodiment, the circuit device 2 includes a drive circuit 21, a buffer circuit 30, a measurement circuit 40, a clock generation circuit 50, a control circuit 60, a register 70, and an interface circuit 80, and further includes a capacitor 90. Note that the circuit device 2 may have a configuration in which some of these components are omitted or changed, or other components are added.

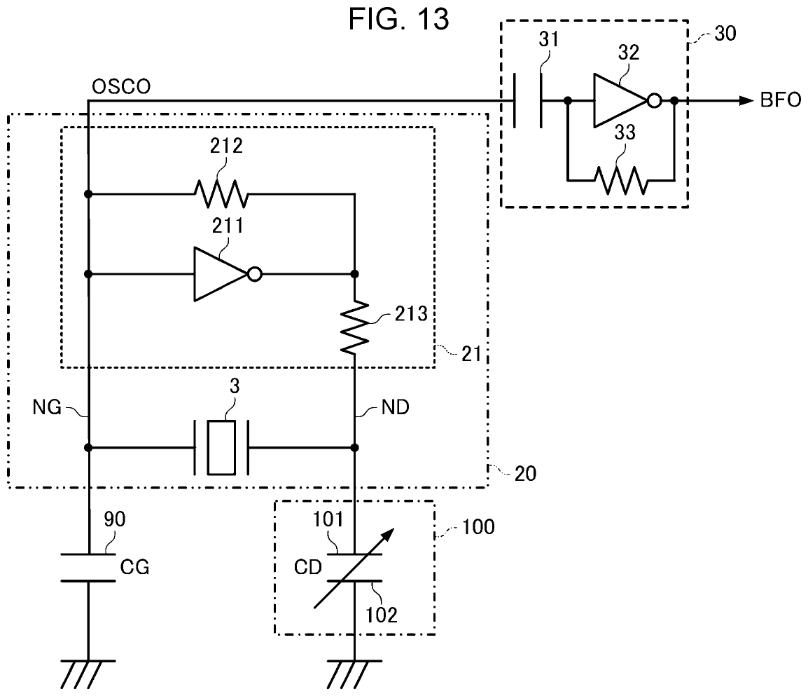

FIG. 13 is a diagram illustrating a configuration example of the drive circuit 21 and the buffer circuit 30 according to the second embodiment. As in the first embodiment, as illustrated in FIG. 13, the drive circuit 21 includes an amplifier 211 and resistors 212 and 213. Furthermore, as in the first embodiment, the buffer circuit 30 includes a capacitor 31, a CMOS inverter circuit 32, and a resistor 33. Since configurations and functions of the drive circuit 21, the buffer circuit 30, the measurement circuit 40, the clock generation circuit 50, the control circuit 60, the register 70, and the interface circuit 80 are the same as those in the first embodiment, descriptions thereof will be omitted.

The electrode 101 of the sensing section 100 is connected to one of an input node NG and an output node ND of the amplifier 211, and the electrode 102 of the sensing section 100 is connected to the ground. In addition, one end of the capacitor 90 is connected to the other of the input node NG and the output node ND of the amplifier 211, and the other end of the capacitor 90 is connected to the ground. In FIGS. 12 and 13, the electrode 101 is connected to the output node ND of the amplifier 211, and one end of the capacitor 90 is connected to the input node NG of the amplifier 211.

Since the capacitor 90 is incorporated in the circuit device 2 and is not formed in the sensing section 100, an electrostatic capacitance CG of the capacitor 90 is a constant value. The electrostatic capacitance CG is, for example, several pF to several tens of pF. Note that the capacitor 90 is provided at least inside the package 4, and may be provided outside the circuit device 2.

A load capacitance C_{L} of the vibrator 3 is configured by the electrostatic capacitance CD between the electrodes 101 and 102 and the electrostatic capacitance CG of the capacitor 90, and is expressed by Expression (4) described above. Then, an oscillation frequency f of the oscillation circuit 20 changes in accordance with the capacitance CD in accordance with above-described Expression (1) to Expression (4).

Other configurations and operations of the capacitance sensor 1 of the second embodiment are the same as those of the capacitance sensor 1 of the first embodiment, and thus descriptions thereof will be omitted.

Note that the electrode 101 is an example of a “first electrode”, the electrode 102 is an example of a “second electrode”, and the electrode 104 is an example of a “ground electrode”. The electrostatic capacitance CD is an example of a “first electrostatic capacitance”. The surface 110a of the substrate 110 is an example of a “first surface”, and the surface 110b of the substrate 110 is an example of a “second surface”.

In the capacitance sensor 1 according to the second embodiment described above, the oscillation circuit 20 oscillates based on a resonance between the vibrator 3 and the electrostatic capacitance CD instead of CR oscillation based on charging and discharging of the electrostatic capacitance CD, and thus is less likely to be affected by external amplitude noise. Therefore, according to the capacitance sensor 1 of the second embodiment, it is possible to detect a capacitance with high accuracy.

Furthermore, in the capacitance sensor 1 of the second embodiment, since the vibrator 3 has a very high Q value, the vibrator 3 also functions as a noise filter, noise input from the electrode 101 of the sensing section 100 connected to the output node ND of the amplifier 211 is considerably reduced by the vibrator 3, and a signal output from the vibrator 3 to the input node NG of the amplifier 211 has little noise and is a signal close to a sine wave. Therefore, according to the capacitance sensor 1 of the second embodiment, it is possible to reduce the possibility that detection accuracy is deteriorated due to noise input from the electrode 101.

In addition, in the capacitance sensor 1 of the second embodiment, since the electrode 104 is disposed on the surface 110b of the substrate 110 at a position facing the region of the arrangement of the electrodes 101 and 102 on the surface 110a, when an object that is not a detection target is positioned to face the surface 110b, the influence of the object on the electrostatic capacitance CD is reduced. Therefore, according to the capacitance sensor 1 of the second embodiment, it is possible to improve the detection accuracy of the electrostatic capacitance.

In addition, according to the capacitance sensor 1 of the second embodiment, since it is possible to realize a reduction in size and a reduction in cost as compared to a capacitance sensor using an LC oscillation circuit, for example, it is possible to easily use the capacitance sensor 1 even when the detection target is a small object.

### 3. Modifications

The present disclosure is not limited to these embodiments, and various modifications can be made within the scope of the spirit of the present disclosure.

For example, in the second embodiment, the electrode 101 of the sensing section 100 is connected to the output node ND of the amplifier 211, and the capacitor 90 is connected to the input node NG of the amplifier 211, but the electrode 101 may be connected to the input node NG, and the capacitor 90 may be connected to the output node ND.

Furthermore, in each of the embodiments described above, the circuit device 2 measures the oscillation frequency f based on the signal BFO and outputs the measured value of the oscillation frequency f to the outside of the oscillator 10, but may output the signal BFO to the outside. The external device may measure the oscillation frequency f, which is the frequency of the signal BFO, and calculate the value of the load capacitance C_{L} based on the measurement value of the oscillation frequency f. In this case, the circuit device 2 do not necessarily include the measurement circuit 40. Alternatively, the circuit device 2 may calculate a value of the load capacitance C_{L} based on the oscillation frequency f and output the value of the load capacitance C_{L} to the outside.

In addition, the oscillator 10 of each of the embodiments described above is a simple oscillator, such as an SPXO, but may be an oscillator having a temperature compensation function, such as a TCXO, or may be an oscillator having a frequency control function, such as a VCXO. SPXO is an abbreviation for Simple Packaged Crystal Oscillator. TCXO is an abbreviation for Temperature Compensated Crystal Oscillator. VCXO is an abbreviation for Voltage Controlled Crystal Oscillator. The oscillator 10 may be an oscillator having a temperature compensation function and a frequency control function, such as a VC-TCXO, or may be an oscillator having a temperature control function, such as an OCXO. VC-TCXO is an abbreviation for Voltage Controlled Temperature Compensated Crystal Oscillator. Furthermore, OCXO is an abbreviation of Oven Controlled Crystal Oscillator.

In addition, in each of the embodiments described above, an example in which the capacitance sensor 1 is used as a sensor for detecting an amount of liquid in a container has been described, but the capacitance sensor 1 can also be used as, for example, a proximity sensor for detecting an approach of a detection target, a touch sensor for detecting a contact of a detection target, and various sensors for detecting rain, fog, ice, snow, gas, and the like. For example, in opening/closing a door of a vehicle, the capacitance sensor 1 can be used as a sensor that detects approach or contact of a finger to the door and outputs a door unlocking signal. The capacitance sensor 1 may also be used as a sensor for determining not only an amount, approach, and contact of a detection target, but also a type of detection target, liquid concentration, and the like.

In addition, a portion of a body of a vehicle may be used as at least a portion of the sensing section 100. For example, a first insulating layer is provided on one of a front surface and a rear surface of a metal plate used as a vehicle body material, and at least one of the electrode 101 and the electrode 103 of the sensing section 100 is provided on a surface of the first insulating layer opposite to the metal plate. Then a second insulating layer is provided on the other of the front surface and the rear surface of the metal plate. When a portion of a human body, such as a finger or a hand, comes into contact with a surface of the second insulating layer on a side opposite to the metal plate, an earth capacitance value of the metal plate changes. The earth capacitance and a capacitance between the metal plate and the electrode disposed on the surface of the first insulating layer opposite to the metal plate are connected in series between the ground potential and the XG terminal or between the ground potential and the XD terminal. With this configuration, it is possible to realize a touch sensor in which a surface of the second insulating layer on a side opposite to the metal plate serves as a contact surface. That is, it is possible to realize a capacitance sensor in which an oscillation frequency changes depending on the presence or absence of contact with the contact surface. Furthermore, with respect to the electrode provided on the surface of the first insulating layer opposite to the metal plate, a third insulating layer may be provided on a surface of the electrode opposite to the first insulating layer. With this configuration, it is possible to realize a touch sensor in which the surface of the third insulating layer on the side opposite to the electrode serves as a contact surface. The metal plate may be an iron plate or an aluminum plate. Furthermore, the first insulating layer and the second insulating layer may be coatings provided on the metal plate. For example, the capacitance sensor may be used as a touch sensor for preventing vehicle theft.

The above-described embodiments and modifications are merely examples, and the present disclosure is not limited thereto. For example, each of the embodiments and each of the modifications may be combined as appropriate.

The present disclosure includes a configuration substantially the same as the configurations described in the embodiments, for example, a configuration having the same function, method, and result, or a configuration having the same purpose and effect. Furthermore, the present disclosure includes configurations in which non-essential portions of the configuration described in the embodiment are replaced. In addition, the present disclosure includes configurations that provide the same operations and effects as the configurations described in the embodiments or includes configurations that can achieve the same purpose as the configurations described in the embodiments. Furthermore, the present disclosure includes configurations in which a known technology is added to the configurations described in the embodiments.

The following contents are derived from the above-described embodiments and modifications.

According to an aspect of the present disclosure, a capacitance sensor includes a package, an oscillation circuit included in the package, and a first electrode and a second electrode that are disposed outside the package. The oscillation circuit includes an amplifier and a vibrator included in the package and connected between an input node and an output node of the amplifier. The first electrode is a sensing electrode connected to one of the input node and the output node of the amplifier. The second electrode has a fixed potential. An oscillation frequency of the oscillation circuit changes in accordance with a first electrostatic capacitance between the first electrode and the second electrode.

In the capacitance sensor, since the oscillation circuit oscillates based on a resonance between the vibrator and the first electrostatic capacitance instead of the CR oscillation based on charging and discharging of the first electrostatic capacitance between the first electrode and the second electrode, the oscillation circuit is not easily affected by external amplitude noise. Therefore, according to the capacitance sensor, it is possible to detect a capacitance with high accuracy.

Meanwhile, since an LC oscillation circuit using an LC resonance generated by an inductor and a capacitance has a wide variable width of an oscillation frequency as compared to an oscillation circuit using a vibrator and a capacitance, it is also considered to configure a capacitance sensor having high detection sensitivity using an LC oscillation circuit. However, for example, in a case where an electrostatic capacitance of the pF order is detected by the capacitance sensor using the LC oscillation circuit, when a small-sized inductor of the nH order is used in order to realize cost reduction, an oscillation frequency becomes the GHz order, and various problems, such as an increase in size or power consumption of the circuit for measuring the electrostatic capacitance, may occur. On the other hand, in order to set the oscillation frequency to the MHz order, an inductor having a large size of the μh order is required to be used, which is an obstacle to the reduction in size and cost of the capacitance sensor.

On the other hand, the oscillation circuit using the vibrator and the capacitance has a considerably narrower variable width of the oscillation frequency than the LC oscillation circuit. However, it is possible to easily realize an oscillation frequency of the kHz order or the MHz order by using a small-sized vibrator, and for example, it is possible to obtain a variable width of the oscillation frequency required for practical use with respect to the electrostatic capacitance of the pF order. Furthermore, since an inductance value of the inductor is determined by size, it is difficult to reduce a size of the inductor without changing an inductance value. On the other hand, in the vibrator, further miniaturization and cost reduction can be realized by the progress of a manufacturing process in the future. Therefore, according to the capacitance sensor, it is possible to realize a reduction in size and a reduction in cost as compared to a capacitance sensor using an LC oscillation circuit.

According to another aspect of the present disclosure, a capacitance sensor includes an oscillation circuit, a first electrode, and a second electrode. The oscillation circuit includes an amplifier and a vibrator connected between an input node and an output node of the amplifier. The first electrode is a sensing electrode connected to one of the input node and the output node of the amplifier. The second electrode has a fixed potential. A first electrostatic capacitance between the first electrode and the second electrode changes in accordance with a state of a detection target. An oscillation frequency of the oscillation circuit changes in accordance with the first electrostatic capacitance.

In the capacitance sensor, since the oscillation circuit oscillates based on a resonance between the vibrator and the first electrostatic capacitance instead of the CR oscillation based on charging and discharging of the first electrostatic capacitance between the first electrode and the second electrode, the oscillation circuit is not easily affected by external amplitude noise. Therefore, according to the capacitance sensor, it is possible to detect a capacitance corresponding to a state of the detection target with high accuracy.

In addition, according to the capacitance sensor, since it is possible to realize a reduction in size and a reduction in cost compared to a capacitance sensor using an LC oscillation circuit, for example, the capacitance sensor can be easily used even when the detection target is a small object.

In an aspect of the present disclosure, the capacitance sensor may further include a buffer circuit to which a signal output from the vibrator to the input node of the amplifier is input, and a measurement circuit that measures a frequency of a signal output from the buffer circuit.

In this capacitance sensor, the vibrator has a very high Q value, and therefore, also functions as a noise filter, and the signal output from the vibrator to the input node of the amplifier has little noise and is close to a sine wave. Therefore, according to the capacitance sensor, since a spike due to noise does not occur in the output signal of the buffer circuit, the possibility that the measurement circuit performs erroneous measurement is reduced.

In an aspect of the capacitance sensor, the capacitance sensor may further include a substrate having a first surface and a second surface which is a rear surface of the first surface, the first electrode and the second electrode may be disposed on the first surface of the substrate, and a ground electrode may be disposed on the second surface of the substrate at a position facing a region of arrangement of the first electrode and the second electrode on the first surface.

In the capacitance sensor, since the ground electrode is disposed on the second surface of the substrate at a position facing the region of the arrangement of the first electrode and the second electrode on the first surface, when an object that is not a detection target is positioned to face the second surface, the influence of the object on the first electrostatic capacitance is reduced. Therefore, according to the capacitance sensor, it is possible to improve the detection accuracy of the electrostatic capacitance.

In an aspect of the capacitance sensor, the first electrode may be connected to the output node of the amplifier.

In the capacitance sensor, since the vibrator has a very high Q value, the vibrator also functions as a noise filter, noise input from the first electrode connected to the output node of the amplifier is considerably reduced by the vibrator, and a signal output from the vibrator to the input node of the amplifier has little noise and is a signal close to a sine wave. Therefore, according to the capacitance sensor, it is possible to reduce the possibility that detection accuracy is deteriorated due to noise input from the first electrode.

In an aspect of the capacitance sensor, the capacitance sensor may further include a third electrode disposed outside the package, the third electrode may be a sensing electrode connected to another of the input node and the output node of the amplifier, and an oscillation frequency of the oscillation circuit may change in accordance with the first electrostatic capacitance and a second electrostatic capacitance between the third electrode and the second electrode.

In the capacitance sensor, since the oscillation frequency of the oscillation circuit changes according to the first electrostatic capacitance and the second electrostatic capacitance, it is possible to widen the variable width of the oscillation frequency compared to a case where the second electrostatic capacitance is not provided. Therefore, according to the capacitance sensor, it is possible to improve the detection sensitivity of the capacitance.

In an aspect of the capacitance sensor, the capacitance sensor may further include a substrate having a first surface and a second surface which is a rear surface of the first surface, the first electrode, the second electrode, and the third electrode may be disposed on the first surface of the substrate, the second electrode may be positioned between the first electrode and the third electrode, and a ground electrode may be disposed on the second surface of the substrate at a position facing a region of arrangement of the first electrode, the second electrode, and the third electrode on the first surface.

In the capacitance sensor, since the ground electrode is disposed on the second surface of the substrate at a position facing the region of the arrangement of the first electrode, the second electrode, and the third electrode on the first surface, when an object that is not a detection target is positioned to face the second surface, the influence of the object on the first electrostatic capacitance and the second electrostatic capacitance is reduced. Therefore, according to the capacitance sensor, it is possible to improve the detection accuracy of the electrostatic capacitance.

What is claimed is:

1. A capacitance sensor comprising:
a package;
an oscillation circuit included in the package; and
a first electrode and a second electrode that are disposed outside the package, wherein
the oscillation circuit includes
an amplifier, and
a vibrator included in the package and connected between an input node and an output node of the amplifier,
the first electrode is a sensing electrode connected to one of the input node and the output node of the amplifier,
the second electrode has a fixed potential, and
an oscillation frequency of the oscillation circuit changes in accordance with a first electrostatic capacitance between the first electrode and the second electrode.

2. A capacitance sensor comprising:
an oscillation circuit; and
a first electrode and a second electrode, wherein
the oscillation circuit includes
an amplifier, and
a vibrator connected between an input node and an output node of the amplifier,
the first electrode is a sensing electrode connected to one of the input node and the output node of the amplifier,
the second electrode has a fixed potential,
a first electrostatic capacitance between the first electrode and the second electrode changes in accordance with a state of a detection target, and
an oscillation frequency of the oscillation circuit changes in accordance with the first electrostatic capacitance.

3. The capacitance sensor according to claim 1, further comprising:
a buffer circuit to which a signal output from the vibrator to the input node of the amplifier is input; and
a measurement circuit that measures a frequency of a signal output from the buffer circuit.

4. The capacitance sensor according to claim 1, further comprising
a substrate having a first surface and a second surface which is a rear surface of the first surface, wherein
the first electrode and the second electrode are disposed on the first surface of the substrate, and
a ground electrode is disposed on the second surface of the substrate at a position facing a region of arrangement of the first electrode and the second electrode on the first surface.

5. The capacitance sensor according to claim 1, wherein
the first electrode is connected to the output node of the amplifier.

6. The capacitance sensor according to claim 1, further comprising
a third electrode disposed outside the package, wherein
the third electrode is a sensing electrode connected to another of the input node and the output node of the amplifier, and
an oscillation frequency of the oscillation circuit changes in accordance with the first electrostatic capacitance and a second electrostatic capacitance between the third electrode and the second electrode.

7. The capacitance sensor according to claim 6, further comprising
a substrate having a first surface and a second surface which is a rear surface of the first surface, wherein
the first electrode, the second electrode, and the third electrode are disposed on the first surface of the substrate,
the second electrode is positioned between the first electrode and the third electrode, and
a ground electrode is disposed on the second surface of the substrate at a position facing a region of arrangement of the first electrode, the second electrode, and the third electrode on the first surface.
